(19) United States
(12) Patent Application Publication
(10) Pub. No.: US 2021/0226219 A1
(43) Pub. Date: Jul. 22, 2021

(54) Electrode for Secondary Battery, Manufacturing Method Thereof, and Secondary Battery Including the Same

(71) Applicant: LG Chem, Ltd., Seoul (KR)

(72) Inventors: Jeong Man Son, Daejeon (KR); Dong Jo Ryu, Daejeon (KR); Seon Hee Han, Daejeon (KR); Jung Sup Han, Daejeon (KR); Min Ah Kang, Daejeon (KR); Cheolhoon Choi, Daejeon (KR)

(73) Assignee: LG Chem, Ltd., Seoul (KR)

(21) Appl. No.: 17/055,845

(22) PCT Filed: Jan. 16, 2020
(86) PCT No.: PCT/KR2020/000801

§ 371 Date: Nov. 16, 2020

(30) Foreign Application Priority Data
Jan. 17, 2019 (KR) 10-2019-0006227
Jan. 15, 2020 (KR) 10-2020-0005491

(51) Int. Cl. H01M 4/62; H01M 4/04; H01M 4/36

(52) U.S. Cl. CPC H01M 4/622; H01M 4/0404; H01M 2004/021; H01M 4/0435; H01M 4/362; H01M 4/0471

(57) ABSTRACT

Provided are an electrode for a secondary battery, a manufacturing method thereof, and a secondary battery including the same. Specifically, according to one embodiment of the present invention, there is provided an electrode for a secondary battery, the electrode including two kinds of binders of which particle diameters are different from each other and distributions in an electrode mixture layer are different from each other.

### CROSS-REFERENCE TO RELATED APPLICATION

The present application is based on, and claims priority from, Korean Patent Application Nos. 10-2019-0006227 and 10-2020-0005491, filed on Jan. 17, 2019 and Jan. 15, 2020, respectively, the disclosures of which are hereby incorporated by reference herein in their entirety.

### TECHNICAL FIELD

The present invention relates to an electrode for a secondary battery, a manufacturing method thereof, and a secondary battery including the same.

### BACKGROUND ART

A rapid increase in the use of fossil fuels has led to an increase in the demand for the use of alternative energy or clean energy. As a part of such demand, most actively investigated fields are power generation/storage applications based on electrochemistry.

At present, a representative example of electrochemical devices using such an electrochemical energy may be a secondary battery, and the application range thereof continues to expand.

In addition, recent increasing concern over environmental issues has brought about a great deal of research associated with electric vehicles and hybrid electric vehicles as substitutes for fossil fuel vehicles such as gasoline vehicles, diesel vehicles, etc., which are a major cause of air pollution, and lithium secondary batteries are being used as a power source of the electric vehicles, hybrid electric vehicles, etc.

As the application field of lithium secondary batteries expands, efforts are being made to solve the insufficient supply by increasing a manufacturing speed.

Efforts are also being made to increase capacity of the secondary battery in order to increase the travel distance of such electric vehicles with a single charge. However, a space in the vehicle is limited, where the secondary battery is mounted, and thus it has been also tried to maximize the energy density of the secondary battery.

In this regard, to increase the energy density, a ratio of an active material in an electrode needed to be increased. However, when the ratio of the active material is increased, a problem of the electrode detachment is further accelerated due to low adhesion to an electrode current collector. At the same time, during a process of manufacturing an electrode using an active material slurry, an excessive amount of the active material is used, while the low adhesion causes a process problem such as contamination of a rolling roll, and thus there is a problem in that production is delayed due to lowered process efficiency such as more frequent cleaning, etc.

Accordingly, there is an urgent demand for technology capable of securing a high level of adhesion while reducing contamination on rolling rolls, even though the ratio of the active material is increased in order to increase the energy density.

### DISCLOSURE

### Technical Problem

There is provided an electrode for a secondary battery that secures binding properties with respect to a conductive material and an active material at the same time and has improved mechanical properties, and a secondary battery that includes the electrode for a secondary battery to have an improved discharge capacity and a reduced electrode expansion rate.

Further, there is provided a method of reducing process time and cost in manufacturing the electrode for a secondary battery.

### Technical Solution

Specifically, in one embodiment of the present invention, there is provided an electrode for a secondary battery, the electrode including two kinds of binders of which particle diameters are different from each other and distributions in an electrode mixture layer are different from each other.

In another embodiment of the present invention, there is provided a method of manufacturing the electrode for a secondary battery of one embodiment by using an active material slurry composition, wherein the active material slurry composition is prepared by preparing a conductive material dispersion by mixing a binder having a relatively small particle diameter with a conductive material and then mixing the conductive material dispersion with a binder having a relatively large particle diameter and an electrode active material.

In still another embodiment of the present invention, there is provided a secondary battery including the electrode for a secondary battery of one embodiment.

### Effect of the Invention

In an electrode for a secondary battery of one embodiment, a binder having a relatively small particle diameter is present on the surface part of a conductive material and a binder having a relatively large particle diameter is present on the surface part of an active material, thereby securing binding properties with respect to the conductive material and the active material at the same time.

As described, when the adhesion is increased, there are effects of improving mechanical properties of the electrode itself, increasing a discharge capacity of a battery including the electrode, and lowering an expansion rate of the electrode during operation of the battery.

In terms of a process, there are effects of preventing electrode contamination and defects, and at the same time, shortening a process time or simplifying the process such as reducing the frequency of roll cleaning by reducing contamination of a rolling roll during the manufacturing process.

### BRIEF DESCRIPTION OF DRAWINGS

FIGS. 1, 3, and 5 show SEM images of the surface of a negative electrode of Example 1 at different magnifications; and

FIGS. 2, 4, and 6 show SEM images of the surface of a negative electrode of Comparative Example 2 at different magnifications.

### DETAILED DESCRIPTION OF THE EMBODIMENTS

The terms used in this description are just for explaining exemplary embodiments and it is not intended to restrict the present invention. The singular expression may include the plural expression unless it is differently expressed contextually. It must be understood that the term “include”, “equip”, or “have” in the present description is only used for designating the existence of characteristics taken effect, steps, components, or combinations thereof, and do not exclude the existence or the possibility of addition of one or more different characteristics, steps, components or combinations thereof beforehand.

The present invention may be variously modified and have various forms, and specific exemplary embodiments are illustrated and explained in detail below. However, it is not intended to limit the present invention to the specific embodiments and it must be understood that the present invention includes every modifications, equivalents, or replacements included in the spirit and technical scope of the present invention.

Hereinafter, an electrode for a secondary battery according to a specific embodiment of the present invention and a manufacturing method thereof will be described in more detail.

Electrode for Secondary Battery

In a specific embodiment of the present invention, provided is an electrode for a secondary battery, wherein an electrode mixture layer is located on at least one side of a current collector, the electrode mixture layer including a plurality of electrode active material particles; a plurality of conductive material particles distributed between the electrode active material particles different from each other; a first binder having a particle diameter of 100 nm or less, which is distributed between the conductive material particles different from each other and between the conductive material particles and the current collector; and a second binder having a particle diameter of 120 nm or more, which is distributed between the electrode active material particles different from each other, between the electrode active material particles and the conductive material particles, and between the electrode active material particles and the current collector.

Here, the particle diameter of each binder represents the particle diameter of individual particles identified in a cross section of the electrode mixture layer.

Distribution patterns of the electrode active material and the conductive material in the electrode mixture layer may vary depending on the particle diameters thereof. In addition, the binding properties with respect to the electrode active material and the conductive material may vary depending on the particle diameters of the binders.

Specifically, it is common that the particle diameter of the electrode active material is larger than that of the conductive material, and the electrode active material particles are uniformly distributed in the electrode mixture layer, and the conductive material may be distributed between different electrode active material particles.

If only a binder, of which particle diameter is similar to the size of the conductive material, is used, a relatively large amount of the binder is distributed in the electrode of the same volume, which may help to bind the conductive material. However, for the binder of which particle diameter is similar to the size of the conductive material, it may be difficult to bind an active material having a larger particle diameter.

In other words, when only a binder, of which particle diameter is similar to the size of the conductive material, is used, even though the binding of the binder to the conductive material is higher than the binding of the binder to the electrode active material, and the conductive material is stably bound during battery operation, the electrode active material is highly likely to be removed.

In contrast, when a binder, of which particle diameter is similar to the size of the electrode active material, is used, it may be helpful in binding the active material. However, a relatively small amount of the binder is distributed in the electrode of the same volume, and it may be difficult to bind an active material having a larger particle diameter than the binder.

In other words, even though the binding of the binder to the electrode active material is higher than the binding of the binder to the conductive material, and the electrode active material is stably bound during manufacturing of the electrode or battery operation, the conductive material is highly likely to be removed.

In consideration of the above problems, one embodiment of the present invention provides an electrode for a secondary battery, the electrode including two kinds of binders of which particle diameters are different from each other and distributions in an electrode mixture layer are different from each other.

A binder having a relatively small particle diameter is present on the surface part of a conductive material and a binder having a relatively large particle diameter is present on the surface part of active materials, thereby securing binding properties with respect to the conductive material and the active material at the same time.

Specifically, the first binder having a relatively small particle diameter may be distributed between the conductive material particles different from each other, and between the conductive material particles and the current collector, and as a result, the first binder enables them to bind with each other.

Further, the second binder having a relatively large particle diameter may be distributed between the electrode active material particles different from each other, and between the electrode active material particles and the current collector, and as a result, the second binder enables them to bind with each other.

Therefore, the binder having a relatively small particle diameter is present on the surface part of the conductive material and the binder having a relatively large particle diameter is present on the surface part of the active material, thereby securing binding properties with respect to the conductive material and the active material at the same time.

Furthermore, when the adhesion of the electrode is increased, there are effects of improving mechanical properties of the electrode itself, increasing a discharge capacity of a battery including the electrode, and lowering an expansion rate of the electrode during operation of the battery.

In terms of a process, there are effects of preventing electrode contamination and defects, and at the same time, shortening a process time or simplifying the process such as reducing the frequency of roll cleaning by reducing contamination of a rolling roll during the manufacturing process.

Hereinafter, the electrode for a secondary battery of one embodiment will be described in detail.

Distribution Patterns of Components of Electrode Mixture Layer

60% by weight or more of the first binder, based on the total weight of the first binder, is present on the surface part of the conductive material particles, thereby binding the conductive material particles, and 60% by weight or more of the second binder, based on the total weight of the second binder, is present on the surface part of the electrode active material particles, thereby binding the active material particles.

Here, the surface part may refer to a part from the particle surface to 1 μm depth in the vertical direction, and may be identified from the surface and the cross section of the electrode mixture layer.

Particle Diameters of Components of Electrode Mixture Layer

With regard to the electrode active material and the conductive material, their particle diameter may be represented by D50. The D50 is a particle diameter at 50% in the cumulative distribution of the number of particles according to the particle diameter, and may be measured using a laser diffraction method. Specifically, powder to be measured is dispersed in a dispersion medium, and then introduced into a commercially available laser diffraction particle size analyzer (e.g., Microtrac S3500) to measure a difference in diffraction patterns according to the particle diameter when the particles pass through a laser beam, thereby calculating particle size distributions. D50 may be measured by calculating the particle diameter at 50% in the cumulative distribution of the number of particles according to the particle diameter in the analyzer.

Meanwhile, the first binder and the second binder are polymer particles and it is difficult to obtain D50 thereof, and thus an average is obtained from the particle diameters of individual particles identified in the cross section of the electrode mixture layer, and the particle diameter may be expressed, based on the average particle diameter.

Based on this definition, the particle diameters of the components of the electrode mixture layer will be explained as follows.

As the conductive material, a conductive material having a particle diameter (D50) within the range of 10 nm to 2 μm may be used. Specifically, a conductive material having a particle diameter (D50) within the range of 20 nm to 1 μm, for example, 30 nm to 100 nm may be used as the conductive material.

As the first binder distributed between the conductive material particles and the current collector, a binder having a particle diameter within the range of 100 nm or less, specifically, 40 nm to 100 nm, for example, 50 nm to 80 nm may be used.

When the first binder is excessively small outside the above range, there is a problem in that handling is difficult in terms of the process and it is difficult to achieve a stable binder. When the first binder is excessively large outside the above range, the first binder may not be distinguished from the second binder, and it may be difficult to improve the binding properties with respect to the conductive material at a desired level.

Meanwhile, as the electrode active material, an electrode active material having a particle diameter (D50) within the range of 500 nm to 50 μm may be used. Specifically, in consideration of capacity, processing, etc., an electrode active material having a particle diameter (D50) within the range of 1 μm to 40 μm, for example, 5 μm to 30 μm may be used as the electrode active material.

As the second binder distributed between the electrode active material particles different from each other, between the electrode active material particles and the conductive material particles, and between the electrode active material particles and the current collector, a binder having a particle diameter of 120 nm or more, specifically 150 nm to 600 nm, for example, 160 nm to 300 nm may be used.

When the second binder is excessively small outside the above range, the second binder may not be distinguished from the first binder, and it may be difficult to improve the binding properties with respect to the electrode active material having a larger particle diameter. When the second binder is excessively large outside the above range, it may be difficult to realize excellent binding strength because the absolute number of particles required for binding of the active material is small.

Kind and Content of Binder

The first binder and the second binder may be of the same type, but may be different from each other only in terms of particle diameter.

For example, the first binder and the second binder may be, in common, one or more polymers of polyvinylidene fluoride, polyvinyl alcohols, carboxymethyl cellulose (CMC), starch, hydroxypropyl cellulose, regenerated cellulose, polyvinyl pyrollidone, tetrafluoroethylene, polyethylene, polypropylene, an ethylene-propylene-diene terpolymer (EPDM), sulfonated EPDM, styrene butadiene latex, fluoro latex, etc., and may be, specifically, as a water-based binder, a styrene-butadiene-based latex having excellent binding strength, e.g., a styrene-butadiene-acrylic polymer.

Such binders may be generally included in an amount of 0.1% by weight to 30% by weight, specifically, 1% by weight to 10% by weight, based on the total weight of the electrode mixture layer.

A weight ratio of the first binder and the second binder may be 1:2 to 1:20, specifically, 1:5 to 1:15.

The above range may be appropriately determined by the contents of the conductive material and the active material, and in general, the content of the second binder is high because the content of the active material is higher than the content of the conductive material.

Kind and Content of Electrode Active Material

The electrode of one embodiment may be any one of a positive electrode and a negative electrode, and therefore, the kind of the electrode active material may be determined as any one of a positive electrode active material and a negative electrode active material.

The positive electrode active material may include, for example, a layered compound such as a lithium cobalt oxide (LiCoO₂), lithium nickel oxide (LiNiO₂) etc., or a compound substituted with one or more transition metals; lithium manganese oxide such as Chemical formula of Li₁₊ₓMn₂₋ₓO₄ (wherein x is 0 to 0.33), LiMnO₃, LiMn₂O₃, LiMnO₂, etc.; lithium copper oxide (Li₂CuO₂); vanadium oxides such as LiV₃O₈, LiV₃O₄, V₂O₅, Cu₂V₂O₇, etc.; a Ni site type lithium nickel oxide represented by Chemical formula of LiNi₁₋ₓMₓO₂ (wherein M=Co, Mn, Al, Cu, Fe, Mg, B, or Ga, and x=0.01 to 0.3); a lithium manganese complex oxide represented by Chemical formula of LiMn₂₋ₓMₓO₂ (wherein M=Co, Ni, Fe, Cr, Zn, or Ta, and x=0.01 to 0.1) or Li₂Mn₃MO₈ (wherein M=Fe, Co, Ni, Cu, or Zn); LiMn₂O₄ wherein Li is partially substituted by alkaline earth metal ions; disulfide compounds; Fe₂(MoO₄)₃, etc., but is not limited thereto.

The negative electrode active material may include, for example, may be made of carbon such as non-graphitizing carbon and graphite-based carbon; metal composite oxides such as LiₓFe₂O₃(0≤x≤1), LiₓWO₂(0≤x≤1), SnₓMe₁₋ₓMe′_{y}O_{z} (Me:Mn, Fe, Pb, Ge; Me′:Al, B, P, Si, Group I, Group II and Group III elements of the Periodic Table of the Elements, or halogens; 0≤x≤1; 1≤y≤3; 1≤z≤8), etc.; lithium metals; lithium alloys; silicon-based alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, Bi₂O, etc.; conductive polymers such as polyacetylene, etc.; Li—Co—Ni based materials, etc.

Generally, the electrode active material may be included in an amount of 60% by weight to 99% by weight, specifically, 80% by weight to 98% by weight, based on the total weight of the electrode mixture layer.

The electrode of one embodiment may be a negative electrode, and therefore, a negative electrode active material may be applied as the electrode active material. In a secondary battery including the negative electrode of one embodiment, a discharge capacity may be improved, and expansion of the negative electrode may be suppressed.

Kind and Content of Conductive Material

Meanwhile, the conductive material improving conductivity between the electrode active material particles is not particularly limited, as long as it is a known conductive material having conductivity without causing chemical changes in a battery, and for example, carbon black such as carbon black, acetylene black, Ketjen black, channel black, furnace black, lamp black, thermal black, etc.; conductive fibers such as carbon fibers, metallic fibers, etc.; metallic powders such as carbon fluoride powder, aluminum powder, nickel powder, etc.; conductive whiskers such as zinc oxide, potassium titanate, etc.; conductive metal oxides such as titanium oxide, etc.; conductive materials such as polyphenylene derivatives, etc. may be used.

Commonly, the conductive material may be included in an amount of 0.1% by weight to 30% by weight, specifically, 1% by weight to 10% by weight, based on the total weight of the electrode mixture layer.

Other Components of Electrode Mixture Layer

Meanwhile, the electrode mixture layer may further include a filler.

The filler is a component optionally used to inhibit expansion of the positive electrode. The filler is not particularly limited, as long as it is a fibrous material without causing chemical changes in a battery. For example, olefinic polymers such as polyethylene, polypropylene, etc.; and fibrous materials such as glass fibers, carbon fibers, etc. may be used. The filler may be included in an amount of 0% by weight to 10% by weight, based on the total weight of the electrode mixture layer.

Current Collector

As mentioned above, the electrode of one embodiment may be any one of a positive electrode and a negative electrode, and therefore, the current collector formed on the electrode mixture layer may be determined as any one of a positive electrode current collector and a negative positive electrode current collector.

The positive electrode current collector is generally fabricated in a thickness of 3 μm to 200 μm. The positive electrode current collector is not particularly limited, as long as it has high conductivity without causing chemical changes in a battery. For example, any one selected from stainless steel, aluminum, nickel, titanium, and aluminum or stainless steel having a surface treated with carbon, nickel, titanium, or silver may be used, and specifically, aluminum may be used. The current collector may also be processed to form fine irregularities on the surface thereof so as to enhance adhesive strength to the positive electrode active material. The current collector may be used in various forms including films, sheets, foils, nets, porous structures, foams, non-woven fabrics, etc.

The negative electrode current collector is generally fabricated in a thickness of 3 μm to 200 μm, and it is not particularly limited, as long as it has conductivity without causing chemical changes in a battery. For example, any one selected from copper, stainless steel, aluminum, nickel, titanium, sintered carbon, and copper or stainless steel having a surface treated with carbon, nickel, titanium, or silver, aluminum-cadmium alloys, etc. may be used. Further, like the positive electrode current collector, the negative electrode current collector may also be processed to form fine irregularities on the surface thereof so as to enhance adhesive strength to the negative electrode active material. The negative electrode current collector may be used in various forms including films, sheets, foils, nets, porous structures, foams, non-woven fabrics, etc.

Method of Manufacturing Electrode for Secondary Battery

Another embodiment of the present invention provides a method of manufacturing an electrode for a secondary battery, the method including the steps of preparing a conductive material dispersion by mixing a first binder having a particle diameter of 100 nm or less with a conductive material; preparing an active material slurry composition by mixing the conductive material dispersion with a second binder having a particle diameter of 120 nm or more and an electrode active material; and obtaining the electrode by applying the active material slurry composition onto at least one side of the current collector, followed by drying and rolling.

This method corresponds to a method of controlling distribution patterns of the first binder and the second binder in the finally obtained electrode by controlling the supply timing of the first binder and the second binder during the process of preparing the active material slurry composition.

Specifically, in the manufacturing method of one embodiment, the binder having a relatively small particle diameter is first mixed with the conductive material to prepare the conductive material dispersion, and the binder having a relatively large particle diameter and the electrode active material are mixed with the conductive material dispersion to prepare the active material slurry composition, which may be used to manufacture the above-described electrode of one embodiment.

According to the manufacturing method of one embodiment, it is possible to obtain an electrode having excellent mechanical properties, electrochemical properties, etc., and in terms of the process, there are effects of preventing electrode contamination and defects, and at the same time, shortening a process time or simplifying the process such as reducing the frequency of roll cleaning by reducing contamination of a rolling roll during the manufacturing process.

Hereinafter, the method of manufacturing the electrode for a secondary battery of one embodiment will be described in detail.

Process of Preparing Binders

The first binder and the second binder may be generally prepared by a known emulsion polymerization method. Specifically, the first binder and the second binder may be each independently prepared by a method including the step of polymerizing monomers in the presence of an emulsifier, a polymerization initiator, and a solvent.

However, in order to allow the first binder and the second binder to have different particle diameters, the content of the emulsifier in the total amount of the monomer, the emulsifier, the polymerization initiator, and the solvent may be adjusted.

More specifically, as the content of the emulsifier is higher, a binder having a relatively small particle diameter may be prepared. In this regard, when the first binder is prepared, the content of the emulsifier in the total amount of the monomer, the emulsifier, the polymerization initiator, and the solvent may be further increased, as compared with the second binder.

Specifically, the content of the emulsifier to prepare the first binder may be more than 0.9 parts by weight, specifically, 1 part by weight to 5 parts by weight, and the content of the emulsifier to prepare the second binder may be 0.9 parts by weight or less, specifically, 0.3 parts by weight to 0.8 parts by weight, based on 100 parts by weight of monomers.

The emulsifier is used for emulsion polymerization, and for example, oleic acid, stearic acid, lauric acid, fatty acid salts such as sodium or potassium salts of mixed fatty acids, general anionic emulsifiers such as rosin acid, etc. may be used, and specifically, a reactive emulsifier to improve stability of polymers may be added. The emulsifier may be used alone or in combination of two or more thereof.

The monomers may be basic monomers that constitute the binder to be prepared. For example, in order to prepare a styrene butadiene latex, which is an example of the first binder and the second binder, a monomer of acrylic acid that imparts hydrophilicity may be used, together with styrene and butadiene.

Further, the polymerization initiator may be an inorganic or organic peroxide. For example, a water-soluble initiator including potassium persulfate, sodium persulfate, ammonium persulfate, etc., or an oil-soluble initiator including cumene hydroperoxide, benzoyl peroxide, etc. may be used.

The polymerization initiator may be included in an amount of 0.01 part by weight to 2 parts by weight, based on 100 parts by weight of the monomers.

Furthermore, an activator to promote the reaction initiation of peroxide may be further included, together with the polymerization initiator, and the activator may include one or more selected from the group consisting of sodium formaldehyde sulfoxylate, sodium ethylenediaminetetraacetate, ferrous sulfate, and dextrose.

The solvent may be an organic solvent or water, specifically, water.

The polymerization temperature and polymerization time for the emulsion polymerization of each binder may be appropriately determined according to the polymerization method or the type of polymerization initiator to be used. For example, the polymerization temperature may be about 50° C. to about 200° C., and the polymerization time may be about 1 hr to about 20 hr.

Process of Preparing Conductive Material Dispersion

When the conductive material dispersion is prepared, it is mixed with the first binder which is a binder improving the binding properties of the conductive material. Optionally, a thickener may be added.

The thickener is to control viscosity, and may be, for example, one or more selected from the group consisting of cellulose polymers, polyethylene glycol, polyacrylamide, poly(N-vinylamide), and poly(N-vinylpyrrolidone), and the cellulose polymers may be one or more selected from the group consisting of carboxymethyl cellulose (CMC), methyl cellulose (MC), hydroxypropyl cellulose (HPC), methyl hydroxypropyl cellulose (MHPC), ethyl hydroxyethyl cellulose (EHEC), methyl ethylhydroxyethyl cellulose (MEHEC), and cellulose gum, and more specifically, carboxymethyl cellulose (CMC).

The thickener solution may be a solution containing the above materials at a concentration of 0.5% to 20%.

The actual content of the thickener may be 50 parts by weight to 100 parts by weight, based on 100 parts by weight of the conductive material and the first binder.

In this regard, a content ratio of the conductive material and the first binder may be 10:1 to 1:1. When the content of conductive material is excessively high outside the above range, it is not preferable because the binder is not sufficient to secure the binding properties of the conductive material. When the content of conductive material is excessively low, it is not preferable because the content of the conductive material itself decreases, resulting in performance degradation of a secondary battery.

Process of Preparing Active Material Slurry Composition

Thereafter, the electrode active material, the solvent, and the second binder may be added to the conductive material dispersion, and this mixture is stirred to complete the active material slurry composition.

In this regard, the electrode active material may be added such that its content in the electrode mixture layer is as described above, and the second binder may also be added at the above-described content ratio with respect to the first binder.

The solvent added in the process (d) may be the same as the solvent used in preparing the conductive material dispersion, for example, an organic solvent or water. Specifically, when the first binder and the second binder are water-based binders, for example, styrene-butadiene-acrylic polymers, the solvent may be water.

As in the present invention, the first binder and the second binder are added at different time points, and the conductive material dispersion is first prepared, and then the slurry is prepared. As a result, the binder having a relatively small particle size may be present on the surface part of the conductive material, and the binder having a relatively large particle size may be present on the surface part of the active material, as described above.

Process of Applying, Drying, and Rolling Active Material Slurry Composition

The electrode, in which the electrode mixture layer is formed on at least one side of the current collector, may be obtained by applying the electrode slurry composition onto at least one side of the current collector, followed by drying and rolling.

The applying, drying, and rolling processes may be performed according to generally known methods, and thus detailed descriptions thereof will be omitted.

The thickness of the electrode mixture layer is not limited, but may be 20 μm to 200 μm on one side.

The manufacturing method of one embodiment may be a method of manufacturing the positive electrode or the negative electrode. Specifically, when it is intended to improve discharge capacity of the secondary battery and to suppress expansion of the negative electrode, the negative electrode may be manufactured by using the negative electrode active material as the electrode active material.

Secondary Battery

Still another embodiment of the present invention provides a secondary battery including the above-described electrode for a secondary battery.

More specifically, the secondary battery may have a structure in which an electrode assembly including the electrode (positive electrode or negative electrode), a counter electrode of the electrode (negative electrode or positive electrode), and a separator interposed between the electrodes is mounted in a battery case, together with an electrolyte liquid.

Hereinafter, other components of the secondary battery will be explained.

As the separator, an insulating thin film having high ion permeability and mechanical strength is used. The separator generally has a pore diameter of 0.01 μm to 10 μm and a thickness of 5 μm to 300 μm. As the separator, for example, sheets or non-woven fabrics, made of a chemical resistant and hydrophobic olefin-based polymer such as polypropylene, etc.; or glass fibers or polyethylene, are used. When a solid electrolyte such as a polymer, etc. is used as an electrolyte, the solid electrolyte may also serve as a separator.

Alternatively, an SRS separator (Safety Reinforced Separator), in which a mixture of inorganic particles and a binder is coated on at least one side of an olefin-based polymer, may be used. Here, in a specific description of the SRS separator, Korean Patent Application No. 10-2008-0005527 of the present applicant is incorporated by reference.

The electrolyte liquid may be a lithium salt-containing non-aqueous electrolyte, and the lithium salt-containing non-aqueous electrolyte consists of a non-aqueous electrolyte liquid and a lithium salt. The non-aqueous electrolyte liquid may be a non-aqueous organic solvent, an organic solid electrolyte, an inorganic solid electrolyte, etc., but is not limited thereto.

As the non-aqueous organic solvent, for example, an aprotic organic solvent such as N-methyl-2-pyrrolidone, propylene carbonate, ethylene carbonate, butylene carbonate, dimethyl carbonate, diethyl carbonate, gamma-butyrolactone, 1,2-dimethoxyethane, tetrahydroxy furan, 2-methyl tetrahydrofuran, dimethyl sulfoxide, 1,3-dioxolane, formamide, dimethylformamide, dioxolane, acetonitrile, nitromethane, methyl formate, methyl acetate, phosphoric acid triester, trimethoxy methane, dioxolane derivatives, sulfolane, methyl sulfolane, 1,3-dimethyl-2-imidazolidinone, propylene carbonate derivatives, tetrahydrofuran derivatives, ether, methyl propinate, ethyl propionate, etc. may be used.

As the organic solid electrolyte, for example, polyethylene derivatives, polyethylene oxide derivatives, polypropylene oxide derivatives, phosphoric acid ester polymers, polyagitation lysine, polyester sulfide, polyvinyl alcohols, polyvinylidene fluoride, polymers containing ionic dissociation groups, etc. may be used.

As inorganic solid electrolyte, for example, nitrides, halides, and sulfates of Li, such as LiN, LiI, Li₅NI₂, Li₃N—LiI—LiOH, LiSiO₄, LiSiO₄_LiI—LiOH, Li₂SiS₃, Li₄SiO₄, Li₄SiO₄_LiI—LiOH, Li₃PO₄_Li₂S—SiS₂, etc., may be used.

The lithium salt is a material that is readily soluble in the non-aqueous electrolyte, and for example, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, (CF₃SO₂)₂NLi, chloroborane lithium, lower aliphatic carboxylic acid lithium, lithium tetraphenyl borate, imide, etc. may be used.

In addition, in order to improve charge/discharge characteristics and flame retardancy, for example, pyridine, triethylphosphite, triethanolamine, cyclic ether, ethylenediamine, n-glyme, hexaphosphoric triamide, nitrobenzene derivatives, sulfur, quinone imine dyes, N-substituted oxazolidinone, N,N-substituted imidazolidine, ethylene glycol dialkyl ether, ammonium salts, pyrrole, 2-methoxy ethanol, aluminum trichloride, etc. may be added to the non-aqueous electrolyte. If necessary, in order to impart incombustibility, halogen-containing solvents such as carbon tetrachloride, ethylene trifluoride, etc. may be further included. In order to improve high-temperature storage characteristics, carbon dioxide gas may be further included. FEC (Fluoro-Ethylene Carbonate), PRS (Propene sultone), etc. may be further included.

In one specific embodiment, the lithium salt-containing non-aqueous electrolyte may be prepared by adding a lithium salt, such as LiPF₆, LiClO₄, LiBF₄, LiN(SO₂CF₃)₂, etc., to a mixed solvent of a cyclic carbonate of EC or PC, which is a high dielectric solvent, and a linear carbonate of DEC, DMC, or EMC, which is a low viscosity solvent.

The present invention also provides a battery pack including the secondary battery as a unit battery, and a device including the battery pack as a power source.

The device may include, for example, laptop computers, netbooks, tablet PCs, mobile phones, MP3s, wearable electronic devices, power tools, electric vehicles (EVs), hybrid electric vehicles (HEVs), plug-in hybrid electric vehicles (PHEVs), electric bicycles (E-bikes), electric scooters (E-scooters), electric golf carts, or power storage systems, but is not limited thereto.

Since the structure and manufacturing method of such a device are well known in the art, detailed descriptions thereof will be omitted herein.

Hereinafter, the present invention will be described with reference to exemplary embodiments. However, these exemplary embodiments will be provided for better understanding of the present invention, and the scope of the present invention is not limited thereto.

### Preparation Example 1

Butadiene (52 g), styrene (46 g), and acrylic acid (2 g) as monomers were added to water containing sodium lauryl sulfate (1 g) as an emulsifier and potassium persulfate (0.2 g) as a polymerization initiator, and they were mixed with each other and allowed to polymerize at 70° C. for about 5 hours to prepare a binder A having a solid content of 40%, in which a particle diameter of the polymerized binder was 80 nm (as measured by a dynamic light scattering (DLS) instrument).

### Preparation Example 2

A binder B having a solid content of 40%, in which a particle diameter of the polymerized binder was 200 nm (as measured by a dynamic light scattering (DLS) instrument), was prepared under the same reaction conditions as in Preparation Example 1, except that 0.5 g of the emulsifier was used.

### Preparation Example 3

A binder C having a solid content of 40%, in which a particle diameter of the polymerized binder was 160 nm (as measured by a dynamic light scattering (DLS) instrument), was prepared under the same reaction conditions as in Preparation Example 1, except that 0.7 g of the emulsifier was used.

### Preparation Example 4

A binder D having a solid content of 40%, in which a particle diameter of the polymerized binder was 50 nm (as measured by a dynamic light scattering (DLS) instrument), was prepared under the same reaction conditions as in Preparation Example 1, except that 2.5 g of the emulsifier was used.

### Example 1

Preparation of Conductive Material Dispersion

1% carboxymethyl cellulose (CMC) solution (100 g), a conductive material (D50: 30 nm, Super-P) (1.5 g), and the binder A (0.5 g) of Preparation Example 1 were stirred at room temperature for 1 hr to prepare a conductive material dispersion.

Preparation of Active Material Slurry Composition

To the prepared conductive material dispersion, artificial graphite (D50: 18 μm, 95 g), distilled water (20 g), and the binder B (5.75 g) of Preparation Example 2 were added and stirred at room temperature for 1 hr to prepare a slurry composition.

Manufacture of Negative Electrode

A copper foil having a thickness of 20 μm was coated with the slurry composition at a loading amount of 8.2 mg/cm², and dried and rolled to a thickness of 80 μm to manufacture a negative electrode.

### Example 2

Preparation of Conductive Material Dispersion

1% carboxymethyl cellulose (CMC) solution (100 g), a conductive material (Super-P) (D50: 30 nm, 1.5 g), and the binder A (1.0 g) of Preparation Example 1 were stirred at room temperature for 1 hr to prepare a conductive material dispersion.

Preparation of Active Material Slurry Composition

To the prepared conductive material dispersion, artificial graphite (D50: 18 μm, 95 g), distilled water (20 g), and the binder B (5.25 g) of Preparation Example 2 were added and stirred at room temperature for 1 hr to prepare a slurry composition.

Manufacture of Negative Electrode

A copper foil having a thickness of 20 μm was coated with the slurry composition at a loading amount of 8.2 mg/cm², and dried and rolled to a thickness of 80 μm to manufacture a negative electrode.

### Example 3

Preparation of Conductive Material Dispersion

1% carboxymethyl cellulose (CMC) solution (100 g), a conductive material (Super-P) (D50: 30 nm, 1.5 g), and the binder D (1.0 g) of Preparation Example 4 were stirred at room temperature for 1 hr to prepare a conductive material dispersion.

Preparation of Active Material Slurry Composition

To the prepared conductive material dispersion, artificial graphite (D50: 18 μm, 95 g), distilled water (20 g), and the binder B (5.25 g) of Preparation Example 2 were added and stirred at room temperature for 1 hr to prepare a slurry composition.

Manufacture of Negative Electrode

A copper foil having a thickness of 20 μm was coated with the slurry composition at a loading amount of 8.2 mg/cm², and dried and rolled to a thickness of 80 μm to manufacture a negative electrode.

### Example 4

Preparation of Conductive Material Dispersion

1% carboxymethyl cellulose (CMC) solution (100 g), a conductive material (D50: 30 nm, Super-P) (1.5 g), and the binder D (1.0 g) of Preparation Example 4 were stirred at room temperature for 1 hr to prepare a conductive material dispersion.

Preparation of Active Material Slurry Composition

To the prepared conductive material dispersion, artificial graphite (D50: 18 μm, 95 g), distilled water (20 g), and the binder C (5.25 g) of Preparation Example 3 were added and stirred at room temperature for 1 hr to prepare a slurry composition.

Manufacture of Negative Electrode

A copper foil having a thickness of 20 μm was coated with the slurry composition at a loading amount of 8.2 mg/cm², and dried and rolled to a thickness of 80 μm to manufacture a negative electrode.

### Comparative Example 1

The process sequence was the same as in Example 1, except that a conductive material dispersion was prepared without using the binder A, and then an active material slurry composition and a negative electrode were prepared.

Preparation of Conductive Material Dispersion

In detail, 1% carboxymethyl cellulose (CMC) solution (100 g) and a conductive material (D50: 30 nm, Super-P) (1.5 g) were stirred at room temperature for 1 hr to prepare a conductive material dispersion.

Preparation of Active Material Slurry Composition

To the prepared conductive material dispersion, artificial graphite (D50: 18 μm, 95 g), distilled water (20 g), and the binder B (6.25 g) of Preparation Example 2 were added and stirred at room temperature for 1 hr to prepare a slurry composition.

Manufacture of Negative Electrode

A copper foil having a thickness of 20 μm was coated with the slurry composition at a loading amount of 8.2 mg/cm², and dried and rolled to a thickness of 80 μm to manufacture a negative electrode.

### Comparative Example 2

The process sequence was the same as in Example 1, except that a conductive material dispersion was prepared by replacing the binder A as follows. The conductive material dispersion thus prepared was mixed with binders A and B to prepare an active material slurry composition, and then a negative electrode was manufactured.

The binder A (0.5 g) prepared in Preparation Example 1 was mixed with the binder B (5.75 g) prepared in Preparation Example 2 to prepare a mixed binder.

Preparation of Conductive Material Dispersion

In detail, 1% CMC solution (100 g) and a conductive material (1.5 g) were stirred at room temperature for 1 hr to prepare a conductive material dispersion.

Preparation of Active Material Slurry Composition

To the prepared conductive material dispersion, artificial graphite (D50: 18 μm, 95 g), distilled water (20 g), and the mixed binder A+B (6.25 g) were added and stirred at room temperature for 1 hr to prepare a slurry composition.

Manufacture of Negative Electrode

A copper foil having a thickness of 20 μm was coated with the slurry composition at a loading amount of 8.2 mg/cm², and dried and rolled to a thickness of 80 μm to manufacture a negative electrode.

### Comparative Example 3

The process sequence was the same as in Example 1, except that a dispersion was prepared by replacing the binder A as follows. Then, an active material slurry composition was prepared, and a negative electrode was manufactured.

In detail, the binder C (0.5 g) was used instead of the binder A to prepare a conductive material dispersion.

Thereafter, in the same manner as in Example 1, an active material slurry composition was prepared, and a negative electrode were manufactured.

### Comparative Example 4

Without separately preparing a conductive material dispersion, a conductive material, an active material, and binders A and B were mixed together to prepare an active material slurry composition, and then a negative electrode was manufactured.

Preparation of Active Material Slurry Composition

In detail, the binder A (0.5 g) prepared in Preparation Example 1 was mixed with the binder B (5.75 g) prepared in Preparation Example 2 to prepare a mixed binder. 1% CMC solution (100 g), a conductive material (1.5 g), artificial graphite (D50: 18 μm, 95 g), distilled water (20 g), and the mixed binder A+B (6.25 g) were mixed at once, and stirred at room temperature for 1 hr to prepare a slurry composition.

Manufacture of Negative Electrode

A copper foil having a thickness of 20 μm was coated with the slurry composition at a loading amount of 8.2 mg/cm², and dried and rolled to a thickness of 80 μm to manufacture a negative electrode.

### Experimental Example 1 (Adhesion of Negative Electrode)

(1) Peeling Test

Each of the negative electrodes manufactured in Examples and Comparative Examples was cut into 60 mm (length)×25 mm (width) to obtain each test specimen.

A double-sided tape was attached to a slide glass, and the test specimen was placed thereon and adhered by reciprocating movement of a 2-kg roller three times, and then pulled at 5 mm/sec using a UTM (TA Company) device to measure a force which was needed to peel the test specimen from the slide glass. At this time, the measuring angle of the slide glass and the electrode was 180°.

The results are shown in Table 1 below.

(2) Evaluation of Surface Contamination of Rolling Roll Before and after Rolling

A rolling roll made of SUS material, which was washed with ethanol, and then dried at room temperature for 10 min or more, was used to roll 4 μm of each negative electrode. Then, color changes of the rolling roll were measured using a portable colorimeter (Konica Minolta, Portable Spectrophotometer) to examine the degree of surface contamination.

The results are shown in Table 1 below.
A clean rolling roll made of SUS material has a chromaticity value of 80, and as it is more contaminated, the chromaticity value decreases.

TABLE 1

| | Adhesion | Chromaticity value of |
|---|---|---|
| | (gf/cm) | rolling roll after 4 m rolling |
| Example 1 | 36 | 79 |
| Example 2 | 34 | 79 |
| Example 3 | 33 | 79 |
| Example 4 | 32 | 79 |
| Comparative Example 1 | 32 | 70 |
| Comparative Example 2 | 30 | 74 |
| Comparative Example 3 | 32 | 75 |
| Comparative Example 4 | 27 | 79 |

According to Table 1, when the electrodes were manufactured according to the present invention, high adhesion and low contamination of the rolling roll were observed. Otherwise, lowered adhesion and considerable contamination of the rolling roll were observed.

### Experimental Example 2 (Evaluation of Distribution Pattern of Each Binder in Negative Electrode)

Each of the negative electrodes of Example 1 and Comparative Example 2 was treated with OsO₄ to stain the binder included in each negative electrode with OsO₄. Thereafter, the surface of each negative electrode was observed by SEM.

As mentioned above, an average is calculated from the diameters of individual particles identified on the surface of the negative electrode (i.e., the cross section of the negative electrode mixture layer), and based on the average particle diameter, the particle diameter of each binder may be expressed.

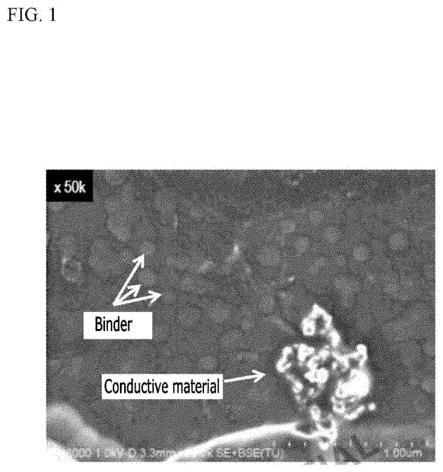

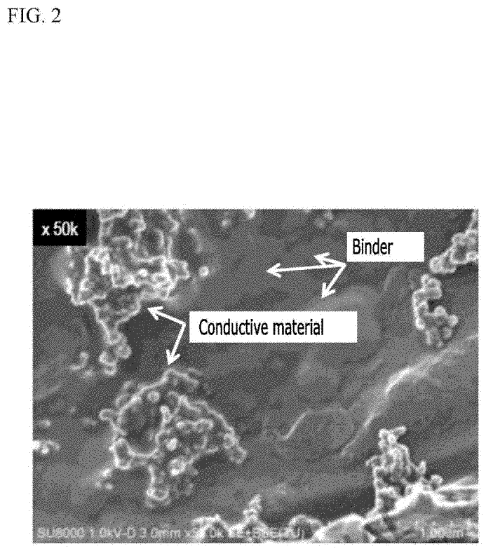

FIGS. 1, 3, and 5 show SEM images of the surface of the negative electrode of Example 1 at different magnifications, and FIGS. 2, 4, and 6 show SEM images of the surface of the negative electrode of Comparative Example 2 at different magnifications.

According to FIGS. 1, 3, and 5, it was confirmed that the binder having a small average particle diameter of 100 μm or less was mainly distributed around the conductive material. In contrast, according to FIGS. 2, 4, and 6, it was confirmed that the binder having a large average particle diameter of 200 μm was mainly distributed around the conductive material.

These results indicate that even though two kinds of binders having different particle diameters are blended at the same ratio, the distribution patterns of the binders in the final negative electrode may differ depending on the supply time of each binder during the process of preparing the active material slurry.

Specifically, as in Example 1, when the binder having the relatively small particle diameter was first mixed with the conductive material to prepare the conductive material dispersion, and then the binder having the relatively large particle diameter and the active material were added to the conductive material dispersion and mixed with each other to prepare the active material slurry composition, the negative electrode in which the binder having the relatively small particle diameter was distributed around the conductive material was finally obtained.

Here, when the particle diameters of the components of the electrode mixture layer are considered, it is apparent that a plurality of conductive material particles are distributed between the electrode active material particles different from each other. Therefore, it can be seen that the binder having the relatively small particle diameter is distributed between the conductive material particles different from each other, and between the conductive material particles and the current collector; and the binder having the relatively large particle diameter is distributed between the electrode active material particles different from each other, between the electrode active material particles and the conductive material particles, and between the electrode active material particles and the current collector.

In contrast, as in Comparative Example 2, when the conductive material dispersion was prepared without the binder, and then two kinds of the binders having different particle diameters and the active material were added at once to the conductive material dispersion and mixed with each other to prepare the active material slurry composition, the negative electrode in which the two kinds of the binders were randomly distributed regardless of the particle diameters thereof was finally obtained.

### Experimental Example 3 (Evaluation of Discharge Characteristics of Battery and Expansion Rate of Negative Electrode)

Each of the negative electrodes manufactured in Examples and Comparative Examples were used as a working electrode, and a lithium metal sheet having a thickness of 150 μm was used as a reference electrode, and a polyethylene separator (thickness: 20 μm, porosity: 40%) was interposed between the working electrode and the reference electrode, and mounted in a battery case, and an electrolyte liquid was injected thereto. Then, a 2032 half-cell type lithium secondary battery was manufactured according to a common manufacturing method.

The electrolyte liquid was prepared by dissolving LiPF₆ at a concentration of 1.3 M in a mixed solvent (a weight ratio of EC:PC:DEC=3:2:5) of ethylene carbonate (EC), propylene carbonate (PC), and diethyl carbonate (DEC), and adding 10% by weight of fluoroethylene carbonate (FEC) as an additive thereto, based on the total weight of the electrolyte liquid.

Each lithium secondary battery was evaluated as follows, and the evaluation results are shown in Table 2 below:

Discharge characteristics of battery: In a constant temperature chamber at 25° C., each lithium ion half-cell was discharged three times in CC/CV mode from 1.5 V to 5 mV at 0.1 C, and then charged to 1.5 V in CC mode at 0.1 C. This cycle was repeated three times, and a 20-minute pause was provided between charging and discharging. The resulting charged battery was finally discharged at 1 C in CC/CV mode, and then the discharge capacity of CC relative to the total discharge capacity was converted into a percentage according to the following equation.

[Discharge characteristics of battery]=100%*{(1.0C CC)})/{(1.0C CC/CV)}

Expansion rate of negative electrode: After evaluating the discharge characteristics, each battery was disassembled to recover the negative electrode. Each recovered negative electrode was washed with a DMC (dimethyl carbonate) solvent, and naturally dried at room temperature for 10 minutes, and then thickness thereof was measured. Accordingly, the measured thickness was substituted into the following equation, and the expansion rate of the negative electrode was calculated.

[Expansion rate of negative electrode]=100%*{(Thickness of negative electrode of discharged battery)−(Thickness of rolled negative electrode)}/{(Thickness of rolled negative electrode)−(Thickness of copper foil)}

Here, definition of each term is as follows:

Thickness of negative electrode of discharged battery=Thickness of negative electrode upon 1^{st} discharging of lithium ion battery

Thickness of rolled negative electrode=Thickness of negative electrode before assembly of lithium ion battery

Thickness of copper foil=Thickness of negative electrode current collector in rolled electrode

TABLE 2

| | 100%*{((1.0 C CC)})/ | Expansion rate of |
|---|---|---|
| | {(1.0 C CC/CV) | negative electrode |
| Example 1 | 40% | 21% |
| Example 2 | 42% | 20% |
| Example 3 | 43% | 20% |
| Example 4 | 44% | 20% |
| Comparative Example 1 | 36% | 23% |
| Comparative Example 2 | 39% | 23% |
| Comparative Example 3 | 38% | 22% |
| Comparative Example 4 | 40% | 22% |

When the results of Table 1 and the results of Table 2 were taken together, it can be seen that Examples are advantageous in securing excellent performances in terms of adhesion of the negative electrode, degree of contamination during rolling, expansion rate of the negative electrode, and rate characteristics, as compared with Comparative Examples.

While exemplary embodiments of the present invention have been described, it will be understood by those skilled in the art to which the present invention pertains that various changes and modifications are possible, based on the above description, within the scope of the present invention.

1. An electrode for a secondary battery, wherein an electrode mixture layer is formed on at least one side of a current collector, the electrode mixture layer comprising:
a plurality of electrode active material particles;
a plurality of conductive material particles, which are distributed between the electrode active material particles different from each other;
a first binder having a particle diameter of 100 nm or less, which is distributed between the conductive material particles different from each other and between the conductive material particles and the current collector; and
a second binder having a particle diameter of 120 nm or more, which is distributed between the electrode active material particles different from each other, between the electrode active material particles and the conductive material particles, and between the electrode active material particles and the current collector.

2. The electrode for a secondary battery of claim 1, wherein the conductive material particle has a D50 particle diameter of 10 nm to 2 μm.

3. The electrode for a secondary battery of claim 1, wherein the first binder has an average particle diameter of 40 nm to 100 nm.

4. The electrode for a secondary battery of claim 1, wherein the electrode active material particle has a D50 particle diameter of 500 nm to 50 μm.

5. The electrode for a secondary battery of claim 1, wherein the second binder has an average particle diameter of 150 nm to 600 nm.

6. The electrode for a secondary battery of claim 1, wherein 60% by weight or more of the first binder, based on a total weight of the first binder, is distributed within a distance from a surface of the conductive material particle to 1 μm depth in a vertical direction.

7. The electrode for a secondary battery of claim 1, wherein 60% by weight or more of the second binder, based on a total weight of the second binder, is distributed on a surface of the electrode active material particle within a distance from the surface of the electrode active material particle to 1 μm depth in a vertical direction.

8. The electrode for a secondary battery of claim 1, wherein both the first binder and the second binder are a styrene-butadiene-acrylic polymer.

9. The electrode for a secondary battery of claim 1, wherein a weight ratio of the first binder and the second binder is 1:2 to 1:20.

10. The electrode for a secondary battery of claim 1, wherein the electrode is a negative electrode.

11. A method of manufacturing an electrode for a secondary battery, the method comprising:
preparing a conductive material dispersion by mixing a first binder having a particle diameter of 100 nm or less with a conductive material;
preparing an active material slurry composition by mixing the conductive material dispersion with a second binder having a particle diameter of 120 nm or more and an electrode active material; and
obtaining the electrode by applying the active material slurry composition onto at least one side of a current collector, followed by drying and rolling.

12. The method of manufacturing an electrode for a secondary battery of claim 11, wherein the first binder and the second binder are each independently prepared by a process comprising polymerizing monomers in the presence of an emulsifier, a polymerization initiator, and a solvent.

13. The method of manufacturing an electrode for a secondary battery of claim 12, wherein, when the first binder is prepared, a content of the emulsifier in a total amount of the monomer, the emulsifier, the polymerization initiator, and the solvent is further increased, as compared with the second binder.

14. The method of manufacturing an electrode for a secondary battery of claim 12, wherein the monomer includes butadiene; styrene; and acrylic acid.

15. A secondary battery comprising the electrode of claim 1, a separator, and an electrolyte.
